(19) United States
(12) Patent Application Publication
(10) Pub. No.: US 2006/0162570 A1
(43) Pub. Date: Jul. 27, 2006

(54) Tea kettle with automatically opening spout lid

(76) Inventors: George Schmidt, Douglaston, NY (US); Alfonso Smaldone, Brooklyn, NY (US)

Correspondence Address: STEVEN HOROWITZ, ESQ., 295 MADISON AVE, SUITE 700, NEW YORK, NY, 10017, US

(21) Appl. No.: 11/043,650

(22) Filed: Jan. 25, 2005

(51) Int. Cl. A23L 1/00

(52) U.S. Cl. 99/275

(57) ABSTRACT

A kettle is presented whose spout lid opens automatically as if by magic when the user chooses to tilt the kettle. When a tea kettle is tilted to pour tea or another liquid, the spout lid opens automatically and in an amount proportional to the amount of the outward swing of a weight up to 27 degrees rotation of that weight. The weight is suspended from a spout lid assembly that sits atop the spout. The weight is coupled to the spout lid assembly by a coupling structure that in a preferred embodiment is a simple metal wire whose bottom portion is affixed to the weight and whose top portion is attached to the spout lid assembly. The weight is prevented from swinging outward more than 27 degrees by a stopper of the spout lid assembly that strikes the spout.

### FIELD OF THE INVENTION

The field of this invention is tea kettles, and more particularly, tea kettles that have a mechanism for automatically opening the spout lid.

### Background of the Invention and Discussion of the Prior Art

A common type of tea kettle is a kettle that whistles to alert the user that the water in the kettle is hot enough, i.e. near boiling point. The user then picks up the kettle and attempts to pour the near boiling liquid out of the kettle.

A number of drawbacks associated with the use of these “whistling” tea kettles exist. One is that when pouring from them it is typically the case that the person holding the kettle has to perform two separate actions to successfully pour the hot water. One hand must lift and hold the kettle by its handle and tilt the kettle, which may be heavy and is definitely very hot on the outside surfaces, and, the other hand, or the same hand, has to open the lid on the spout of the kettle in order to permit water to pour out of the spout. In theory one could always open the lid prior to lifting the kettle but doing so may cause water to spill from the kettle if one is walking a significant distance with the kettle. Or one could intend to open the lid prior to lifting the kettle but forget to do so and be left with the need to open the lid while holding the kettle. Consequently, there are many scenarios in which the user has to open the spout lid while holding a heavy and very hot kettle.

If the user first picks up the kettle with one hand, it is awkward to have to then manually open the spout lid. Besides the awkwardness of opening the spout lid while holding the kettle, opening the spout lid under any condition could be a tricky challenge due to the very hot surfaces on the kettle including the spout lid. It is noted that the spout lid is at least hot enough to allow hot steam from the liquid to traverse the hole in the lid, the process that generates the whistling sound. The user is pouring the kettle precisely because the water within it has approached boiling point and sufficient steam from the near-boiling water rushes past the hole in the spout lid.

Some kettles have a plastic or rubber fixture affixed to the back of the metal spout lid so that the spout lid can be opened by pressing down on this fixture rather than by having to directly touch the actual hot lid. This is not a perfect solution however, because it still requires two actions to be performed—one, to pour the hot liquid out by tilting the kettle and two, to press down with an extended finger or fingers on the spout lid or on a plastic addendum affixed to the back of the spout lid. An additional problem is that there is always a risk of accidentally touching the metal portion of the spout lid or kettle adjacent the heat resistant fixture. The chance of this happening is heightened by the fact that the user is often trying to press down on the back of the spout lid to open it while simultaneously holding a heavy metal kettle filled with near boiling liquid.

The insertion of this plastic or rubber fixture is also not a perfect solution because of the manufacturing difficulty of securely attaching the rubber or plastic fixture to the metal without it falling off.

U.S. Pat. No. 6,006,959 is a kettle that attempts to solve the above problem by providing a kettle whose spout lid opens when the kettle handle is rotated. This kettle's spout lid, however, does not close automatically when the kettle is restored to its upright position—one has to manually close the spout lid after each instance of pouring. In addition, the spout lid on this kettle has only two positions. The lack of an in-between position between “open” and “closed” constitutes a drawback in certain situations. For example, a kettle may be heated in the kitchen but poured from in the dining room. If the user wants to lift the kettle and let off some steam from the kettle to cool off the water after it whistles but does not want to let too much steam out of the kettle while transporting the kettle from the kitchen to the dining room table, the user may not want the spout lid completely open. Furthermore, having an open position and a closed position for the spout lid is prosaic and not interesting. There is a need for a more interesting alternative. An additional drawback of the design in the '959 patent is that the mechanism for causing the automatic opening of the spout lid is an intricate physical shape that may be disfavored by manufacturers.

The present invention addresses the above problems and solves them in a manner that provides advantages not taught or demonstrated by the prior art.

### SUMMARY OF THE PRESENT INVENTION

A kettle is presented whose spout lid opens automatically as if by magic when the user chooses to tilt the kettle. When a tea kettle is tilted to pour tea or another liquid, the spout lid opens automatically and in an amount proportional to the amount of the outward swing of a weight, at least during the up to 27 degree outward rotation of that weight. The weight is suspended from a spout lid assembly that sits atop the spout. The weight is coupled to the spout lid assembly by a coupling structure that in a preferred embodiment is a simple metal wire whose bottom portion is affixed to the weight and whose top portion is attached to the spout lid assembly. The weight is prevented from swinging outward more than 27 degrees by a stopper of the spout lid assembly that strikes the spout. The stopping mechanism and the position of the spout lid assembly along the spout together with the length and angle of the spout also ensure that the weight is not in the path of the falling stream of liquid being poured from the spout of the kettle.

In a preferred embodiment, the spout lid assembly includes a bracket welded to the top surface of the spout, a stationary bracket cover, the spout lid, a movable plastic extension extending backward from the spout lid to the bracket and a lock plate that captures the top portion of the coupling structure in a frictional fit.

### IMPORTANT OBJECTS AND ADVANTAGES

The following important objects and advantages of the present invention are:

(1) to provide a kettle whose spout lid opens automatically when the kettle is tiled;

(2) to provide a kettle that is safe to pour hot liquid from;

(3) to provide a kettle that can be used to pour hot liquid from without having to use two hands;

(4) to provide a kettle that can be used to pour boiling liquid from without having to touch the spout lid;

(5) to provide a kettle whose spout lid opens in an amount proportional to the amount that the pourer tilts the kettle, at least over a certain range of angles of the tilt;

(6) to provide a kettle that does not require moving around one's fingers to manipulate any part of the kettle while pouring;

(7) to provide a kettle that is easy to pour from;

(8) to provide a kettle that is sleek;

(9) to provide a kettle that is interesting to operate;

(10) to provide a kettle that opens using gravity;

(11) to provide a kettle whose automatic spout lid opening mechanism can be used regardless of the amount of liquid in the tea kettle;

(12) to provide a kettle whose automatic spout lid opening mechanism can be used regardless of the materials used in the construction of the kettle;

(13) to provide a kettle that pours automatically in a reliable manner;

(14) to provide an automatically pouring tea kettle that is easy to manufacture;

(15) to provide a kettle whose spout lid closes automatically when you put the kettle down or restore it to an upright position;

(16) to provide a kettle that is easy to use;

(17) to provide a kettle that has a weight suspended from a spout lid assembly;

(18) to provide such a kettle wherein the weight never comes into contact with the body of the kettle even during the use of the kettle; and

(19) to provide such a kettle wherein the automatic spout lid opening mechanism, including the weight, does not interfere with the process of pouring the liquid from the kettle or get in the path of the liquid being poured from the kettle.

### BRIEF DESCRIPTION OF THE DRAWINGS

FIG. 1 is a left side view of the tea kettle of the present invention;

FIG. 2 is a front view thereof;

FIG. 3 is a right side view thereof;

FIG. 4 is a rear view thereof;

FIG. 5 is a top view thereof;

FIG. 6 is a bottom view thereof;

FIG. 7 is a perspective view thereof;

FIG. 8 is a left side view thereof in a tilted position during pouring;

FIG. 9 is a sectional view taken along line 9-9 of FIG. 3 with spout lid closed;

FIG. 9A is a sectional view similar to FIG. 9 but with the bracket cover partially broken away and the spout lid in an open position;

FIG. 10 is a fragmentary perspective view of the bracket attached to the spout in the kettle of the present invention;

FIG. 11A is a side view of a portion of the spout lid and spout lid extension in the spout lid assembly of the kettle of the present invention; and

FIG. 11B is a top view of the top portion of the coupling structure in the kettle of the present invention.

### DETAILED DESCRIPTION OF THE PREFERRED EMBODIMENT

The apparatus of the present invention will now be illustrated by reference to the accompanying drawings. The kettle of the present invention has been assigned reference numeral 10. Other elements have been assigned the reference numerals referred to below.

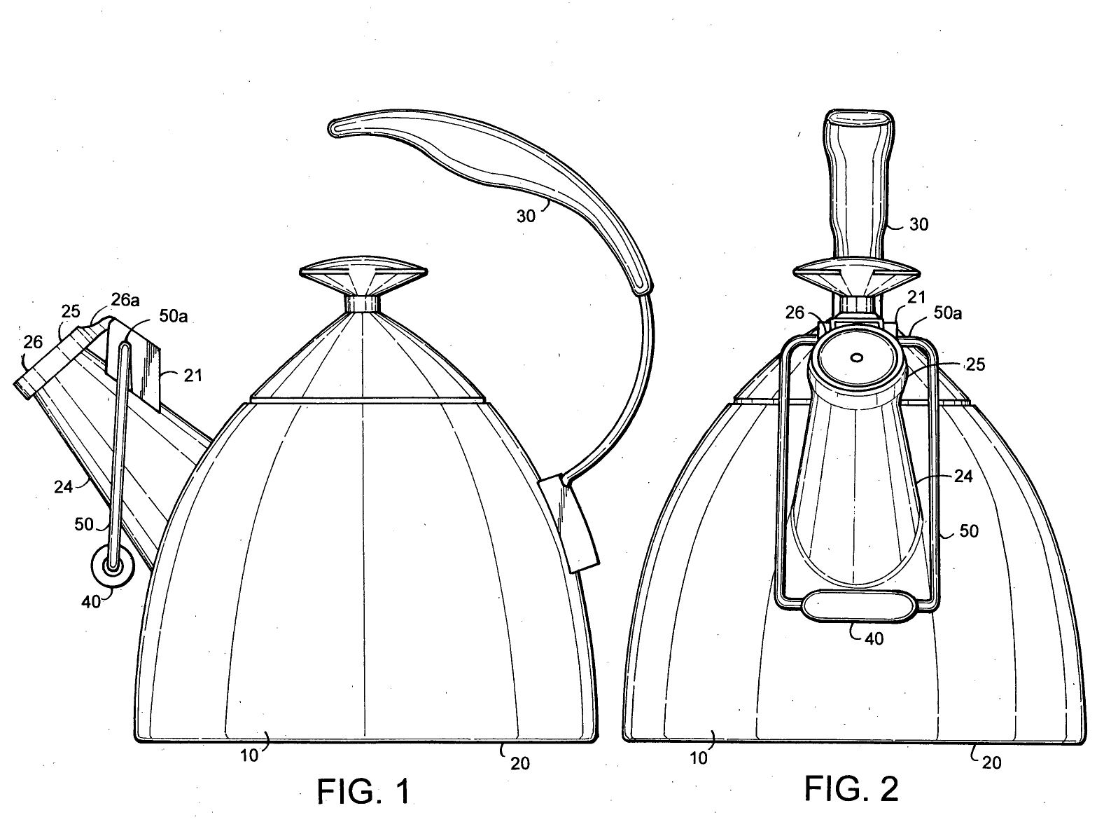

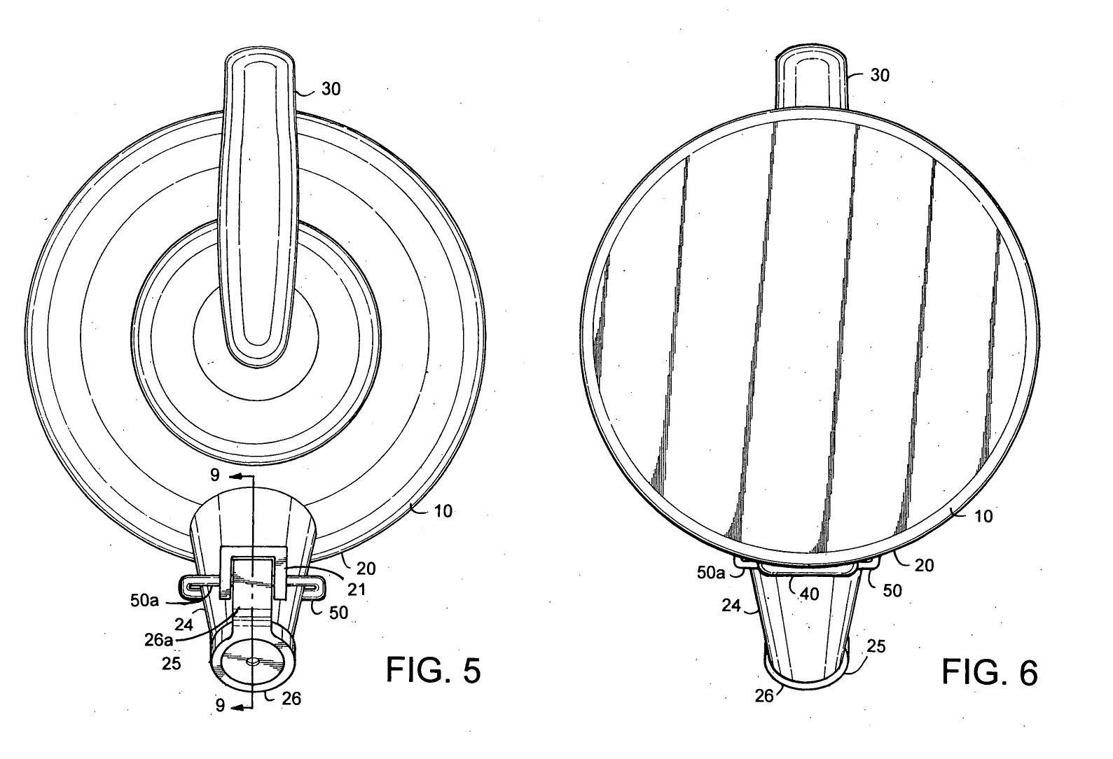

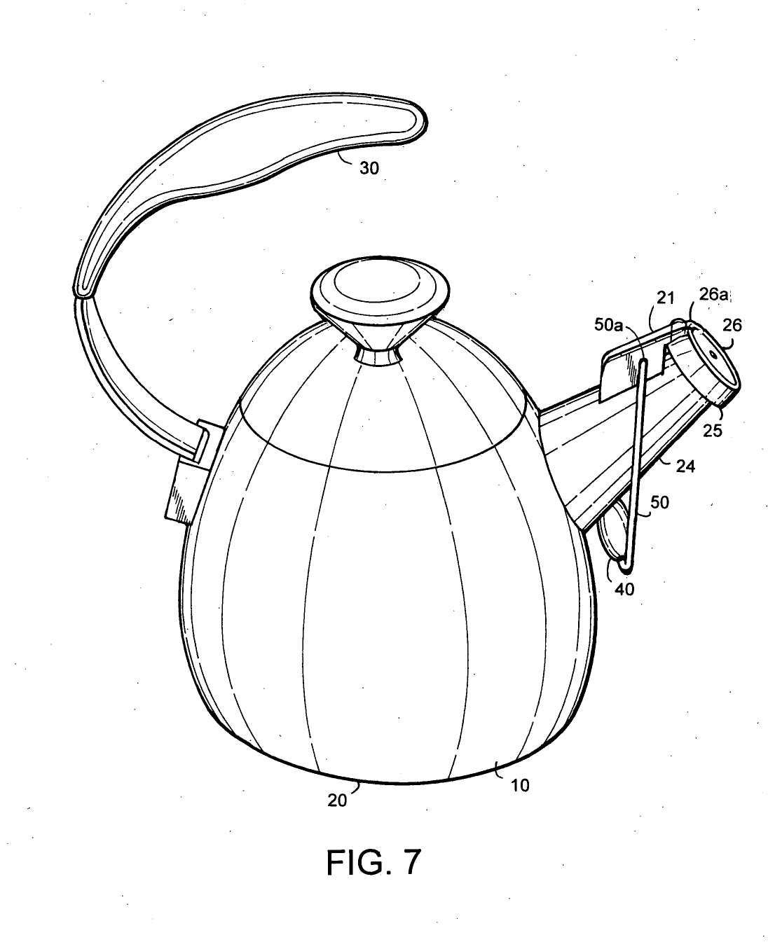

As seen from FIGS. 1-11B, a kettle 10 for holding a liquid such as tea is presented. The kettle 10 comprises a body 20 defining a cavity (not shown in drawings) for storing a liquid, the body 20 having a spout 24 defining an opening into the cavity, the spout 24 for pouring the liquid out of the cavity. Kettle 10 also includes a spout lid assembly 25 sitting atop the top surface of spout 24. The spout lid 26 of spout lid assembly 25 typically has a hole in its center for emitting steam from the liquid stored in the kettle 10 in a manner that causes a whistling sound. The present invention, however, is not necessarily limited to kettles having an aperture in their spout lid. The cavity in body 20 is a storage space for a liquid, such as is used in the inside of tea kettles.

In a preferred embodiment, the spout lid assembly 25 has been defined as including the spout lid 26, the spout lid extension 26a, the lock plate 29 and stopping member 88, the stationary bracket 21 sitting on the spout 24 and the bracket cover 87. Spout lid assembly is thus defined to include everything situated above spout 24, except for the top portion of the coupling structure 50. The movable portion of spout lid assembly 25 includes the spout lid 26, spout lid extension 26a and lock plate 29 but not bracket 21 or bracket cover 87.

The kettle 10 also includes a handle 30, preferably made out of a non-slip material, a weight 40 and a coupling structure 50 coupling the weight 40 to the spout lid assembly 25. The weight 40 is suspended from the spout lid assembly 25 by the coupling structure 50 and the weight 40 is free to swing outward, that is away from body 20, from a standing position nearly adjacent body when body 20 is tilted for pouring. The swinging of weight 40 outward causes spout lid 26 to open in an amount proportional to the degree to which weight 40 swings outward up to 27 degrees rotation of weight 40.

It is noted that the description of weight 40 as swinging “outward” refers to its swinging away from body 20. “Outward” is a term that is relative to the body 20 of kettle 10. Thus, when body 20 of kettle 10 is tilted, weight 40 actually remains stationary in its rotational relationship relative to the floor. This requires weight 40 to swing outward relative to body 20.

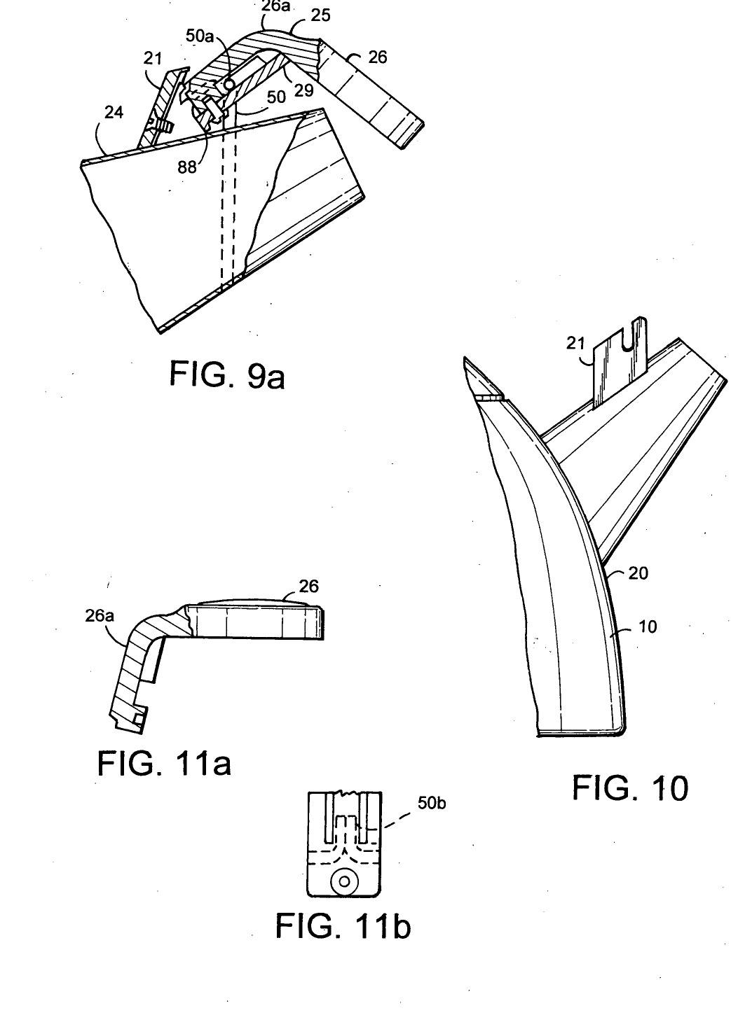

Coupling structure 50 can be anything that couples weight 40 to spout lid assembly 25. In a preferred embodiment, coupling structure 50 is an elongated metal wire whose top portion 50a is securely attached to the spout lid assembly 25. The specific means of secure attachment is not essential, although a particular means of such secure attachment is described below and in FIGS. 9, 9A.

It is noted that welding plastic to metal is not typically an ideal way to make a secure attachment. Kettle 10, including coupling structure 50 is preferably made of metal. Spout lid assembly 25 is preferably made of plastic, except for bracket 21 and spout lid 26 of spout lid assembly 25 which are made of metal, in the case of lid 26 to accommodate the hot steam whistling out of it. Accordingly, in a preferred embodiment, coupling structure 50 is attached to spout lid assembly 25 via a frictional fit. Thus, for example, a top portion 50a of coupling structure 50 is disposed within spout lid assembly 25 by a frictional fit between lock plate 29 and spout lid extension 26a. In part to assist in maintaining such a frictional fit, lock plate 29, preferably made of plastic, forms part of spout lid assembly 25.

In one alternative embodiment, coupling structure 50 can be welded or glued to spout lid assembly 25.

The spout lid assembly 25 is not limited to the structure described above in the accompanying drawings. Spout lid assembly 25 must, however, be attachable to coupling structure 50 and be capable of opening spout lid 26 with the outward swinging of weight 40. Preferably, such opening of lid 26 should be through a continuous spectrum of rotational positions and be able to operate so that liquid in body 20 pours out safely from spout 24 of kettle 10 without coming into contact with weight 40 or otherwise interfering with the automatic spout lid opening mechanism. In a preferred embodiment, spout lid assembly 25 includes spout lid extension 26a that extends backward from lid 26 along a top surface of spout 24 to a point from which coupling structure 50 holding weight 40 can be suspended without touching liquid pouring from spout 24.

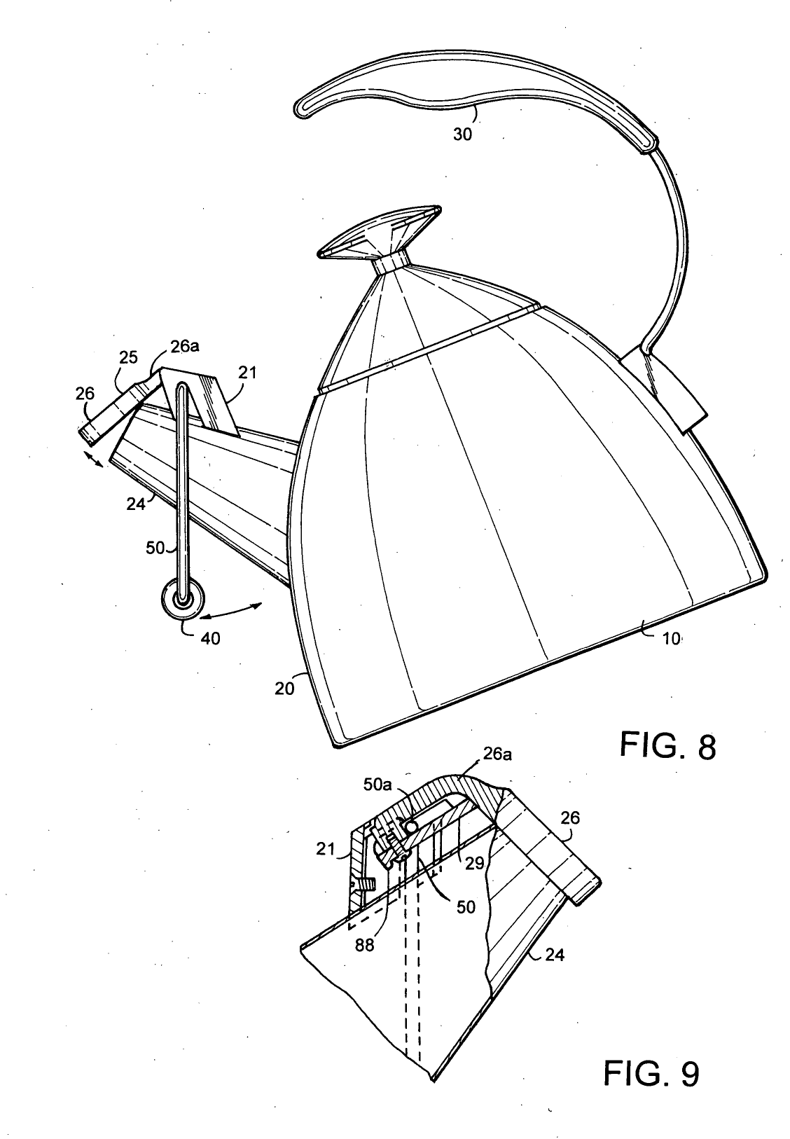

In the closed position shown in FIGS. 1-7, the spout lid 26 covers the spout 24. In an open position, as best seen from FIG. 8, and FIG. 9A, spout lid 26 opens in a continuous spectrum of rotational degrees sufficient to allow liquid to pour comfortably out of spout 24.

In a preferred embodiment, spout lid assembly 25 includes a bracket 21 that is welded to the top surface of spout 24. The bracket 21 is stationary and in one embodiment contains semi-arcuate grooves on each side to allow elongated top portion 50a of coupling structure 50 to rest thereon. The spout lid extension 26a together with lock plate 29 also rest on bracket 21 in a manner that allows this movable part of spout lid assembly 25 including lid 26 to move or rotate relative to spout 24. As best seen in FIG. 11b, the middle part of the top portion 50a of coupling structure 50 projects in a direction perpendicular to the remainder of top portion 50a of coupling structure 50 and thereby presses against the moving part of spout lid assembly 25 so that when weight 40 swings outward the moving part of spout lid assembly 25 also moves. This is best appreciated from FIGS. 9, 9A, 11b showing that the main portion of spout lid assembly 25 is able to move relative to bracket 21 and relative to spout 24 while bracket cover 87 is stationary.

As best seen from FIGS. 8 and 9, when a user grasps handle 30 to tilt kettle 10, the existence of coupling structure 50 securely coupling spout lid assembly 25 to weight 40 causes the outward swinging of weight 40 to pull the movable portion of spout lid assembly 25 (that is, all of spout lid assembly 25 except for bracket 21 and bracket cover 87) backward thus opening lid 26.

It is noted that at no time is weight 40 or coupling structure 50 in contact with the body 20 of kettle. A small clearance is maintained between body 20 of kettle and weight 40 (as well as coupling structure 50) by positioning bracket 21 of spout lid assembly 25, from which coupling structure 50 holding weight 40 is suspended, just far enough along spout 24 to create a small clearance of approximately one quarter inch. Thus, use of kettle will not lead to weight 40 scratching or damaging body 20 of kettle. As best appreciated from FIG. 8, weight 40 swings outward away from body 20 up to a maximum point representing approximately 27 degrees of rotational movement from the standing position of weight 40 depicted in FIGS. 1, 3, 7 near body 20 of kettle.

Although weight 40 can be made of any material and be shaped in any form that does not result in weight 40 banging into body 20 during use, in one preferred embodiment, weight 40 comprises a dense metal such as lead. In this manner, weight 40 need not be too bulky. Weight 40 needs to be heavy enough to exert a force sufficient to pull downward against spout lid assembly 25 but that force need not be very much. In a preferred embodiment, weight 40 weighs approximately two to three ounces for a kettle 10 that is made primarily of metal and has a total weight of between approximately one pound 12 ounces and approximately two pounds and 10 ounces.

It is noted that the above automatic spout lid opening mechanism works well regardless of the amount of liquid in the kettle 10 and it works well essentially independent of the weight of kettle body 20. Notwithstanding this, spout lid 26 should preferably be made of a sufficiently heavy material such as metal to ensure that lid 26 does not open suddenly by the weight of weight 40 when kettle 10 is tilted for pouring.

The automatic spout lid opening mechanism described above for the present invention also functions independent of the material that the kettle 10 is made of and independent of the weight of the kettle 10. However, in one preferred embodiment, body 20 should be at least heavy enough to ensure that swishing back and forth of liquid inside body 20 does not unduly shake kettle 10 and hence interfere with the smooth performance of the mechanism for opening of spout lid 26. This is accomplished by maintaining the walls of body 20 thick enough (or using heavy enough material) to make body 20 weigh enough using well known techniques and materials known in the art of kettle manufacturing. For example, in one preferred embodiment wherein the material of the entire kettle 10 is made of enamel on steel except for the plastic portion of spout lid assembly 25 (everything except bracket 21 and lid 26) and except for the weight 40 (which is made of lead), the total weight of the tea kettle 10 is approximately 2 pounds and 10 ounces. In a second preferred embodiment, wherein everything in kettle 10 except the weight 40 and plastic portion of spout lid assembly 25 is made of stainless steel, the entire kettle 10 weighs approximately 1 pound and 12 ounces. The weight of weight 40, in a preferred embodiment, is approximately 2 to 3 ounces, and in one preferred embodiment ideally 2.5 ounces.

In order for the self-pouring mechanism to operate effectively, it is obviously advantageous that the liquid being poured out of kettle 10 not strike weight 40. To accomplish this objective, the bracket 21 holding the top portion 50a of coupling structure 50 carrying weight 40 should be placed along spout 24 at a position that puts it sufficiently away from body 20. Consistent with this objective, spout 24 should not be unduly short, the angle that spout 24 makes with body 20 should not be steep and a stopping mechanism should be employed, typically as part of spout lid assembly 25.

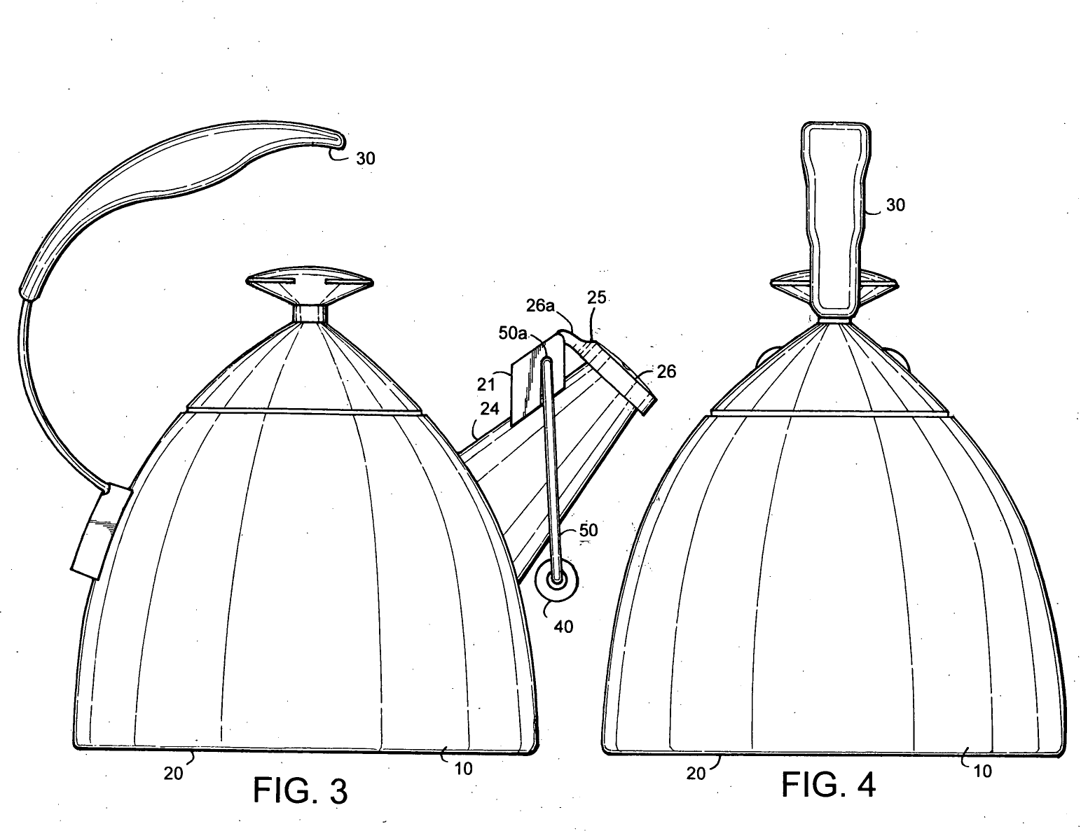

Although the present invention is in no way limited to any particular dimension, angle or type of material, purely by way of illustration, in one preferred embodiment, the objective of the pouring liquid not falling into weight 40 is accomplished by making spout 24 approximately 3 and ¾ inches long on its bottom surface and approximately 3 inches long on its top surface, making the angle that spout 24 makes with the body 20 of kettle 10 approximately as shown in FIGS. 1 and 3 and having the point at which the top portion 50a of coupling structure 50 crosses the top surface of spout 24 be approximately 1 and ¾ inches from body 20 as measured along the top surface of spout 24.

As noted, a stopping mechanism is also used to prevent the spout lid 26 from opening too much, which in turn prevents the weight 40 from swinging out too far. The stopping mechanism can be anything that is suitable to accomplish this purpose. In one preferred embodiment of the stopping mechanism, lock plate 29 of spout lid assembly 25 includes a stopping member 88. In this embodiment, the end of lock plate 29 that is distal to the spout lid 26 contains a lip 88 that will strike spout 24 after a certain amount of rotational opening of spout lid 26. Thus, in a preferred embodiment, upon weight 40 swinging outward approximately 27 rotational degrees from its standing position, lip 88 contacts spout 24. Alternatively, lock plate 29 has no lip but is long enough to bump into spout 24 at a certain point in the rotation of movable portion of spout lid assembly 25 relative to spout 24, i.e. upon weight 40 swinging outward approximately 27 degrees.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A kettle, comprising:
a body for storing a liquid, the body having a spout defining an opening into the body, the spout for pouring the liquid out of the body,
a spout lid assembly including a spout lid,
a handle,
a weight,
a coupling structure coupling the weight to the spout lid assembly,
the weight suspended from the spout lid assembly by the coupling structure and the weight free to swing outward from a standing position when the body is tilted for pouring such that the spout lid opens in an amount proportionate to a degree of an outward swing of the weight.

2. The kettle of claim 1, wherein spout lid assembly includes a stopping member that is capable of limiting the outward swing of the weight.

3. The kettle of claim 2, said stopping member having an end distal to the spout lid, said end capable of striking the spout to limit the outward swing of the weight.

4. The kettle of claim 3, wherein the outward swing of the weight cannot exceed approximately 27 rotational degrees.

5. The kettle of claim 2, wherein a top portion of the coupling structure is attached to the spout lid assembly.

6. The kettle of claim 5, wherein the top portion of the coupling structure is disposed within the spout lid assembly.

7. The kettle of claim 6, wherein the top portion of the coupling structure is disposed within the spout lid assembly by a frictional fit.

8. The kettle of claim 7, wherein the spout lid assembly includes a spout lid extension, a lock plate, a bracket, said bracket attached to a top surface of spout and a bracket cover.

9. The kettle of claim 7, wherein the spout lid assembly also includes a spout lid extension, and wherein the spout lid and spout lid extension move upon the outward swing of the weight.

10. The kettle of claim 9, wherein the spout lid assembly is made of plastic except for the spout lid and wherein the coupling structure is made of metal.

11. The kettle of claim 10, wherein the coupling structure is an elongated metal member.

12. The kettle of claim 8, wherein the coupling structure is an elongated metal member.

13. The kettle of claim 1, wherein a top portion of the coupling structure is attached to the spout lid assembly.

14. The kettle of claim 13, wherein the top portion of the coupling structure is disposed within the spout lid assembly.

15. The kettle of claim 14, wherein the top portion of the coupling structure is disposed within the spout lid assembly by a frictional fit.

16. The kettle of claim 15, wherein the outward swing of the weight cannot exceed approximately 27 rotational degrees.
